(19) United States
(12) Patent Application Publication
(10) Pub. No.: US 2012/0288595 A1
(43) Pub. Date: Nov. 15, 2012

(54) Closed Loop Adaptive Control System for Cooking Appliance

(76) Inventors: Larry Randall, Coral Springs, FL (US); Eric O'Neill, Boynton Beach, FL (US); Kenny J. Yang, WuHan (CN)

(21) Appl. No.: 13/511,704

(22) PCT Filed: Nov. 10, 2010
(86) PCT No.: PCT/US2010/056235

§ 371 Date: May 24, 2012

Related U.S. Application Data
(60) Provisional application No. 61/302,579, filed on Feb. 9, 2010.

(51) Int. Cl. H05B 1/02; A23L 1/01

(52) U.S. Cl. 426/231; 219/490

(57) ABSTRACT

A cooking application (10) is provided having an adaptive control system (50) to control the cooking temperature of a food product. The adaptive control system (50) includes cooking profiles for select food products, where the cooking profiles include temperature profiles for various cooking times. A temperature measuring system (40) is utilized to verify and maintain the temperature of the food product in accordance with a temperature profile for a selected food product and cook time. The temperature profiles ensure that the food product is provided in a cooking state, preventing over or under-cooking, for the selected cooking time.

### FIELD OF THE INVENTION

The present invention generally relates to cooking appliances and more particularly to cooking appliances having an adaptive control system to control the cooking temperature of a food product for a selected cooking time.

### BACKGROUND OF THE INVENTION

Time and convenience are in short supply for homemakers wishing to supply a home-cooked meal to family members. Some appliances, such as slow-cooker appliances, attempt to meet this need by providing all-day cooking while a homemaker is absent. Such appliances, however, tend to be of the type where only one temperature and all day cooking is possible, regardless of the food item, and thus potentially subjecting the food item to over- or under-cooking. Another option may be to use a cooking unit with a controller, where a user may set a time or temperature desired. These units, however, use only a single temperature, low, medium, or high, during the cooking cycle.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a exemplary cooking appliance of the present disclosure;

FIG. 2 depicts a cooking unit for the cooking appliance of FIG. 1;

FIG. 3 depicts the cooking appliance of FIG. 1 including a temperature probe;

FIG. 4 depicts a block diagram of a control system for the cooking appliance of FIG. 1;

FIG. 5 depicts cooking profiles for a first exemplary food product;

FIG. 6 depicts cooking profiles for a second exemplary food product;

FIG. 7 depicts a flow chart of the adaptive cooking system of the present disclosure;

FIG. 8 depicts a flow chart of the activation of the cooking profile; and

FIG. 9 depicts a flow chart of the cooking profile temperature verification.

### DETAILED DESCRIPTION OF THE INVENTION

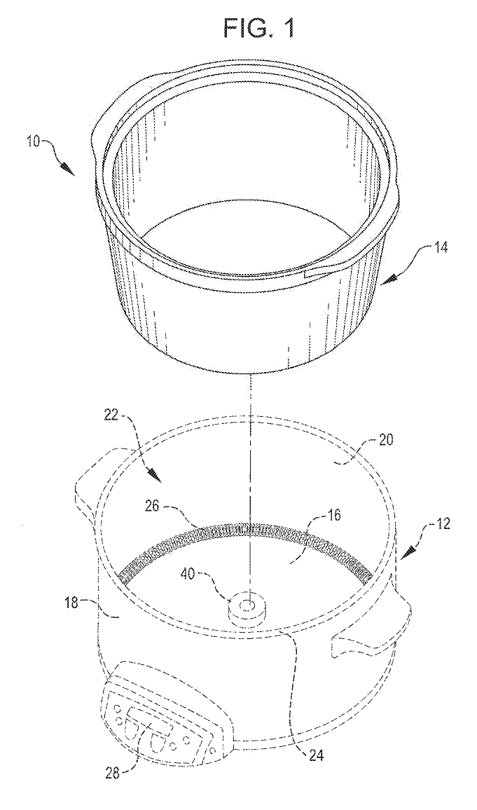

Referring to FIG. 1, illustrated is an embodiment of a cooking appliance which may include a slow-cooker appliance 10. It should be understood that the slow-cooker appliance 10 illustrated is not meant to be limiting as the cooking appliance may include other cooking appliances in other embodiments.

In the illustrated embodiment, the slow-cooker appliance 10 has a heating unit 12 and a cooking unit 14. The heating unit 12 has a bottom 16 and a continuous outer sidewall 18. The bottom 16 and an interior sidewall 20 define a well-like heating chamber 22 having a circular or oval cross-section. The interior sidewall 18 defines an annular lip 24 at an upper edge of the outer sidewall 18 and the interior sidewall 20. The heating chamber 22 has a heating element 26 disposed therein and mounted to the heating unit 12, either in the bottom 16 and/or between the outer sidewall 20 and the interior sidewall 20. In an embodiment, a programmable controller 28 is mounted to the heating unit, and operates to control the function of the heating element 26.

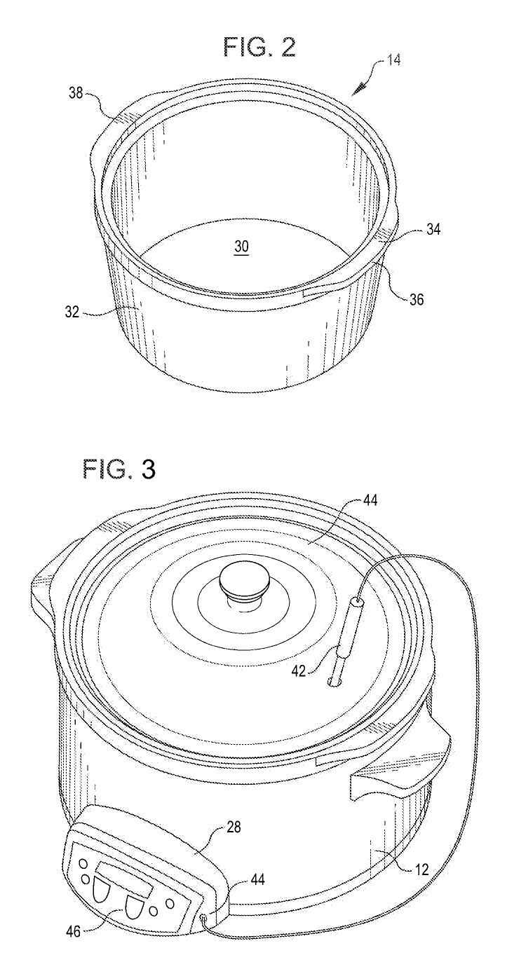

Referring to FIG. 2, the cooking unit 14 has a bottom 30 with a continuous sidewall 32 upstanding therefrom. The continuous sidewall 32 has an annular lip 34 projecting in flange-like fashion from the upper end 36 thereof. The cooking unit 14 is adapted to be at least partially received within the heating unit 12 with the annular lip 34 of the cooking unit 14 engaging the annular lip 24 of the heating unit 12, supporting the cooking unit 14 within the heating unit 12. The annular lip 34 can further define a pair of handle portions 36 and 38 to facilitate lifting the cooking unit 14. In an embodiment, the cooking unit 14 can be made of ceramic with a coating of conventional glazing compound. In other embodiments, the cooking unit can be made from aluminum, cast iron, or other suitable material.

The thermal and heat retaining properties of the ceramic cooking unit 14 allow it to conduct heat from the heating chamber 22 through the sidewall 32. This provides even heating throughout the cooking unit 14.

In an embodiment, the temperature of the food product in the cooking unit 14 of the slow cooker appliance 10 is measured using a thermistor 40 (FIG. 1), or other temperature measuring devices, which is affixed in the heating unit 12, in thermal contact with the cooking unit 14. The thermistor 40 (FIG. 1) can be affixed to the bottom 16 or interior side wall 20 of the heating unit 12, being in thermal contact with the cooking unit 14. The measured temperature is provided as an input into the programmable controller 28.

In another embodiment, as shown in FIG. 3, the temperature measuring device can be a temperature probe 42. The temperature probe 42 is positionable through a lid 44, covering the cooking unit 14, being in thermal communication with the food stuff in the cooking unit 14. The temperature probe 42 measures the temperature of the food stuff, providing the measured temperature to the programmable controller 28.

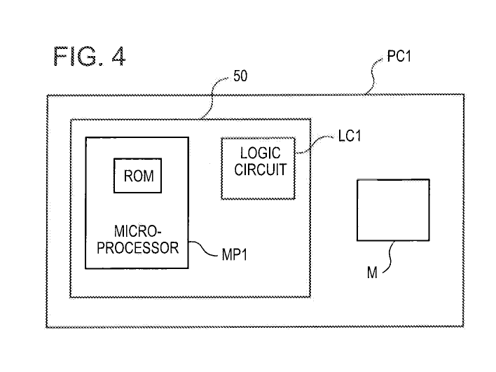

Referring now to FIGS. 3 and 4, in an embodiment the programmable controller 28 can include a housing 44 and user interface 46 for attachment to or in the outer sidewall 18 of the heating unit 12. The interior of the housing 44 can contain a printed circuit board PC1 having electronic components for controlling the operation of the heating element 26 (FIG. 1). In another embodiment, the circuit board PC1 can be mounted in the base of the heating unit 12. In each case, the circuit board PC1 can be thermally protected by means of thermal insulators and/or air vents to limit the transfer of heat from the heating element 26 (FIG. 1) to the circuit PC1.

The circuit board PC1 mounts circuitry and logic allowing the user of the slow cooker appliance 10 to electronically control and program cooking cycles. The circuit board PC1 is built around a microprocessor MP1. In an embodiment, the microprocessor MP1 can be an application-specific integrated circuit (ASIC) programmable controller or similar device. The ASIC programmable controller may also include an algorithm for controlling the operation of the slow-cooker appliance 10 (FIG. 1), and at least enough memory to store the algorithm in ROM (read only memory).

In an embodiment, the programmable controller 28 can include a variety of stored recipes to assist in preparing meals to be cooked. The various recipes are stored in nonvolatile memory M accessible by the microprocessor MP1. The stored recipes include food specific cooking parameters which include time based temperature settings through a cooking cycle.

Exemplary programmable slow cookers are provided in U.S. Pat. No. 6,872,921 entitled Programmable Slow-Cooker Appliance and U.S. Pat. No. 7,109,445 entitled Cook Apparatus With Electronic Recipe Display, the contents of which are herein incorporated by reference in their entirety.

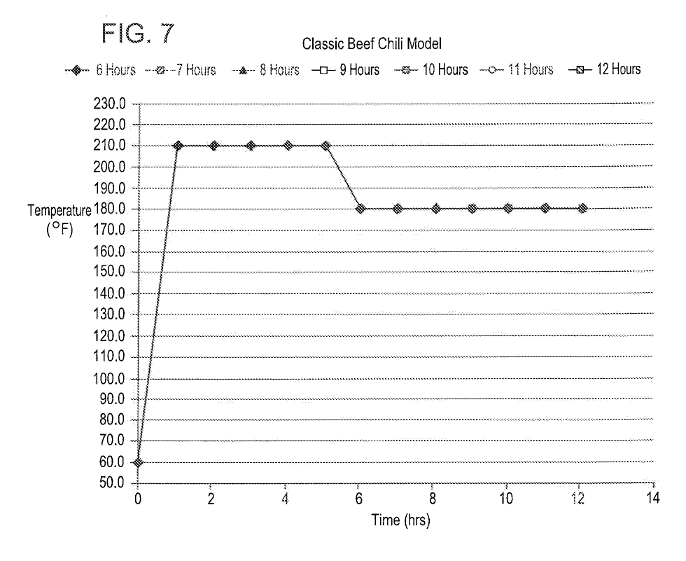

In an embodiment, the programmable controller 28 can further include an adaptive control system (50) incorporated into the circuit board PC1, either being hard wired into the circuit board PC1 as a logic circuit LC1 and/or preprogrammed into the microprocessor MP1. The adaptive control system 50 includes logic (FIG. 7) which enables a user to select a specific recipe or food product and a cook time for the cooking cycle. The preprogrammed recipe includes cooking profiles for the cooking cycle at a selected cook time, including a temperature ramp up time, plateau time, and serve temperature time. As such, the cooking temperature through the cooking cycle is adaptively controlled to prevent over cooking and under cooking of the food product at the selected cooking time.

For example, a user selects a food product from a recipe list preprogrammed into the programmable controller. The user also selects a cooking cycle cook time from a range of cook times, 6 hrs-12 hrs. The logic (FIG. 7) controls the cooking temperature of the food product throughout the cook cycle, adaptively adjusting the cooking temperature. The actual (current) food stuff temperature is measured using the temperature indicating device, inputting the temperature reading to the programmable controller 28. In response, the programmable controller 28 continually adjusts the power to the heating elements, adjusting the cooking temperature. In this manner, the programmable controller 28 adaptively, continually, adjusts the cooking temperature to match the cooking profile for the selected recipe and cook time throughout the cooking cycle.

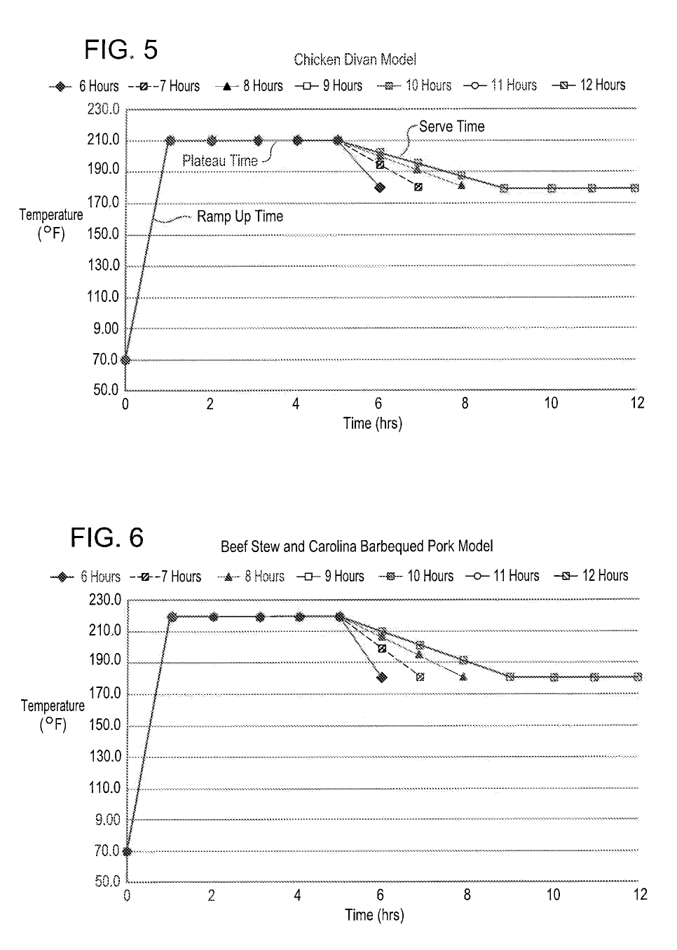

Referring to FIG. 5, in an embodiment cooking profiles are provided for an exemplary recipe of chicken divan for cooking times of 6, 7, 8, 9, 10, 11, and 12 hours. As noted in the FIG. 5 graph, upon completion of the cooking time the food product is ready for serving at a temperature of 180° F. Table 1 provides the cooking temperature profile for the selected cook time at hourly time intervals. As with the graph in FIG. 5, at the end of the cook time the food product is at a serving temperature of 180° F.

TABLE 1

| | Cook Set Time (“St”) | | | | | | |
|---|---|---|---|---|---|---|---|
| Time (hrs) | 6 | 7 | 8 | 9 | 10 | 11 | 12 |
| 0 | 70.0 | 70.0 | 70.0 | 70.0 | 70.0 | 70.0 | 70.0 |
| 1 | 210.0 | 210.0 | 210.0 | 210.0 | 210.0 | 210.0 | 210.0 |
| 2 | 210.0 | 210.0 | 210.0 | 210.0 | 210.0 | 210.0 | 210.0 |
| 3 | 210.0 | 210.0 | 210.0 | 210.0 | 210.0 | 210.0 | 210.0 |
| 4 | 210.0 | 210.0 | 210.0 | 210.0 | 210.0 | 210.0 | 210.0 |
| 5 | 210.0 | 210.0 | 210.0 | 210.0 | 210.0 | 210.0 | 210.0 |
| 6 | 180 | 195.0 | 200.0 | 202.5 | 202.5 | 202.5 | 202.5 |
| 7 | | 180.0 | 190.0 | 195.0 | 195.0 | 195.0 | 195.0 |
| 8 | | | 180.0 | 187.5 | 187.5 | 187.5 | 187.5 |
| 9 | | | | 180.0 | 180.0 | 180.0 | 180.0 |
| 10 | | | | | 180.0 | 180.0 | 180.0 |
| 11 | | | | | | 180.0. | 180.0 |
| 12 | | | | | | | 180.0 |

It is also noted that the cooking temperature profile is a function of the food stuff to be cooked. For example, in another embodiment illustrated in FIG. 6, cooking profiles are provided for an exemplary recipe of Beef Stew and Carolina Barbequed Pork for cooking times of 6, 7, 8, 9, 10, 11, and 12 hours. As noted in the FIG. 6 graph, upon completion of the cooking time the food product is read for serving at a temperature of 180° F. Table 2 provides the cooking temperature profile for the selected cook time at hourly time intervals. As with the graph in FIG. 6, at the end of the cook time the food product is at a serving temperature of 180° F.

TABLE 2

| | Cook Set Time | | | | | | |
|---|---|---|---|---|---|---|---|
| Time (hrs) | 6 | 7 | 8 | 9 | 10 | 11 | 12 |
| 0 | 70.0 | 70.0 | 70.0 | 70.0 | 70.0 | 70.0 | 70.0 |
| 1 | 220.0 | 220.0 | 220.0 | 220.0 | 220.0 | 220.0 | 220.0 |
| 2 | 220.0 | 220.0 | 220.0 | 220.0 | 220.0 | 220.0 | 220.0 |
| 3 | 220.0 | 220.0 | 220.0 | 220.0 | 220.0 | 220.0 | 220.0 |
| 4 | 220.0 | 220.0 | 220.0 | 220.0 | 220.0 | 220.0 | 220.0 |
| 5 | 220.0 | 220.0 | 220.0 | 220.0 | 220.0 | 220.0 | 220.0 |
| 6 | 180.0 | 200.0 | 206.7 | 210.0 | 210.0 | 210.0 | 210.0 |
| 7 | | 180 | 193.7 | 200.0 | 200.0 | 200.0 | 200.0 |
| 8 | | | 180.0 | 190.0 | 190.0 | 190.0 | 190.0 |
| 9 | | | | 180.0 | 180.0 | 180.0 | 180.0 |
| 10 | | | | | 180.0 | 180.0 | 180.0 |
| 11 | | | | | | 180.0. | 180.0 |
| 12 | | | | | | | 180.0 |

In the above noted graphs and tables, the time intervals are provided on a uniformly hourly basis. However, it is contemplated that the time intervals can be greater then or less then an hourly basis. Additionally, the time intervals can be provided in no uniform manner. It should be appreciated that the foregoing examples of cooking temperature profiles are not meant to be limiting as there may be other cooking temperature profiles known one of ordinary skill in the art or developed in the future.

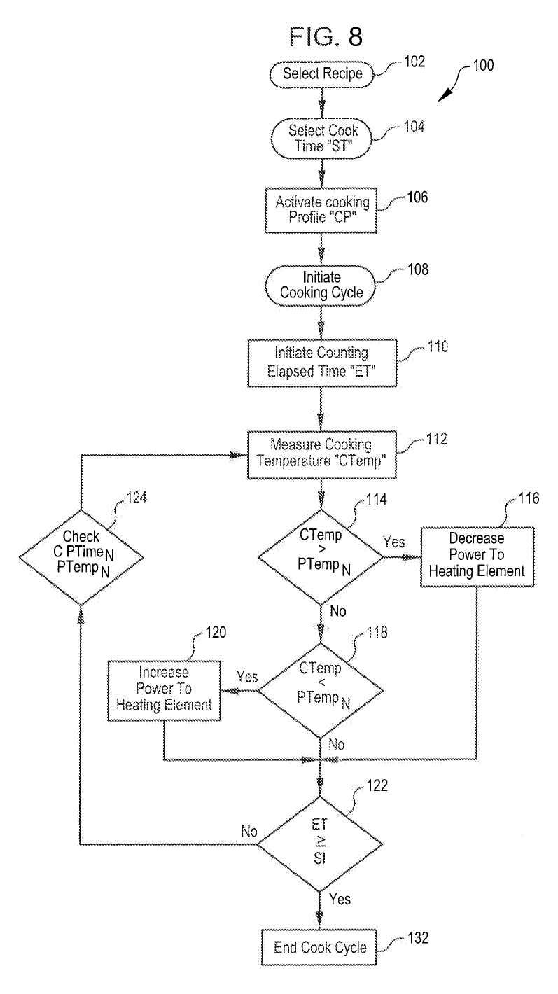

Referring to FIG. 7, a flow chart of an embodiment of the adaptive control system 100 is provided. Upon placement of the ingredients in the cooking unit 14 (FIGS. 1 and 2), using the user interface 46 (FIG. 3) a user selects a recipe 102 and a cooking (set) time (“ST”) for the cooking cycle 104. The selection of the recipe and ST makes active a corresponding cooking profile (“CP”) 106. The activation of the CP initializes the CP counter “N” 106a and sets the cooking profiles temperatures (“PTemp_{N}”) 106b. (See FIG. 8) As noted in Tables 1 and 2, the CP includes a series of cooking profile temperature (“PTemp_{N}”) at specified cooking profile time intervals (“CPTime_{N}”). (See also FIGS. 5 and 6)

For example, referring to FIG. 5 and Table 1, at a cooking (set) time of 9 hrs, there are 9 cooking time intervals temperature profiles. At the first time interval, the temperature is raised from an ambient temperature to a specified cooking profile temperature. For the next four time intervals, the cooking profile temperature is maintained at a fixed temperature. For the final four time intervals, the temperature incrementally decreases, to a final temperature.

Referring again to FIG. 7, the user initiates the cooking cycle 108, simultaneously a cook timer is activated 110. The cooking timer clocks the elapsed cooking time (“ET”).

Using the temperature measuring device, the current temperature (“CTemp”) of the food product in the cooking unit 14 (FIGS. 1 and 2) is measured 112 and provides it to the programmable controller 28 (FIGS. 1 and 3). The CTemp is compared to the cooking profile temp (“PTemp_{N}”) at the corresponding CPTime_{N}. If the CTemp is greater than the PTemp_{N} 114, the programmable controller 28 (FIGS. 1 and 3) decreases power to the heating element 26 (FIG. 1) to decrease the CTemp 116. If the CTemp is less than the PTemp_{N} 118, the programmable controller 28 (FIGS. 1 and 3) increases power to the heating element 26 (FIG. 1) to increase the CTemp 120.

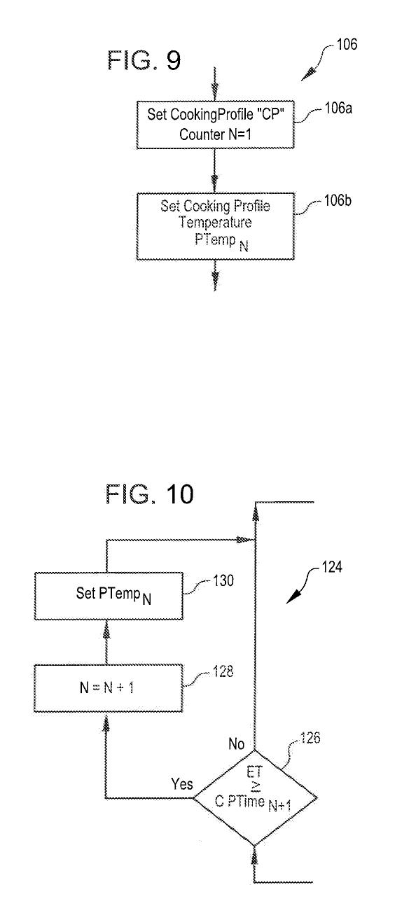

The ET is compared to the ST 122. If the ET is less than the ST, the CPTime_{N} will be compared to the ET to verify that the appropriate PTemp_{N} is set 126. (see FIG. 9) If the ET is greater than or equal to the current CPTime_{N}, the cooking profile counter “N” is advanced 128 and the appropriate PTemp_{N} is set 130.

The process will be continually repeated until the ET is equal to or greater than the ST. Upon which the cooking cycle is complete and power is removed 132 from the heating element 26 (FIG. 1).

In another embodiment, when the ET is equal to or greater than the ST, the programmable controller 28 (FIGS. 1 and 3) can automatically place the slower cooker appliance 10 into a keep warm cycle. In the keep warm cycle the programmable controller 28 (FIGS. 1 and 3) uses the temperature measuring device input to maintain the food at a temperature between 140° F. and 160° F.

The programmable controller 28 (FIGS. 1 and 3) automatically reduces power to the heating element 26 (FIG. 1) to put the slower cooker appliance 10 (FIG. 1) in a WARM setting. The slower cooker appliance 10 (FIG. 1) will stay in the WARM setting until the user pushes the OFF button or unplugs the unit. Of course, other programming schemes are possible.

In another embodiment, the programmable controller 28 (FIGS. 1 and 3) can initially remove power from the heating element 26 (FIG. 1). In a first instant, the programmable controller 28 (FIGS. 1 and 3) will provide a reduced power to the heating element 26 (FIG. 1) after a predetermined time period has elapsed. In a second instant, the programmable controller 28 (FIGS. 1 and 3) will provide a reduced power to the heating element 26 (FIG. 1) when the CTemp of the food reaches threshold temperature (“TTEMP).

While in the above disclosure the cooking appliance has been described as a slow-cooker appliance 10 (FIG. 1), it is contemplated that the adaptive control system 50 (FIG. 4) of the present disclosure can be utilized in other embodiments of a cooking appliance, including but not limited to a roaster, steamer, pressure cooker, skillet, and the like.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A cooking appliance (10), comprising:
a heating element (26); and
a control system (28) configured to control the heating element (26) to adjust cooking temperature throughout a selected cooking cycle time according to a cooking profile stored in memory (M) of the control system (28), wherein the control system (28) comprises:
an adaptive control system (50) that includes logic configured to allow a desired food product and a desired cooking cycle time to be selected and then activate a corresponding cooking profile that includes adjusting cooking temperature throughout the selected cooking cycle time.

2. The cooking appliance (10) of claim 1, wherein the control system (28) includes a housing (46), a user interface (48), and a printed circuit board (PC1) that includes electronic components for controlling operation of the heating element (26).

3. The cooking appliance (10) of claim 1, wherein the corresponding cooking profile throughout the cooking cycle time includes temperature ramp up time, plateau time, and serve temperature time.

4. The cooking appliance (10) of claim 2, wherein the control system (28) further comprises a logic circuit (LC1) mounted on the circuit board (PC1) that includes the logic for controlling operation of the heating element (26).

5. The cooking appliance (10) of claim 2, wherein the control system (28) further comprises a microprocessor (MP1) mounted on the circuit board (PC1) that includes the logic for controlling operation of the heating element (26).

6. The cooking appliance (10) of claim 1, wherein the cooking appliance (10) is a slow-cooker, roaster, steamer, pressure cooker or skillet.

7. A cooking appliance (10), comprising:
a housing (18);
a thermally conductive liner (16,20) disposed within the housing (18);
a heating element (26) disposed in contact with the thermally conductive liner (16,20);
a cooking chamber (14) removably inserted within the thermally conductive liner (16,20); and
a controller (28) including an adaptive control system (50) and memory (M).

8. The cooking appliance (10) of claim 7, wherein the controller (28) comprises a controller housing (46), a user interface (48), and a printed circuit board (PC1) that includes electronic components for controlling operation of the heating element (26).

9. The cooking appliance (10) of claim 7, wherein the adaptive control system (50) comprises logic configured to allow a pre-determined food product and a desired cooking cycle time to be selected and then activate a corresponding cooking profile.

10. The cooking appliance (10) of claim 9, wherein the corresponding cooking profile throughout the cooking cycle time includes temperature ramp up time, plateau time, and serve temperature time.

11. The cooking appliance (10) of claim 8, further comprising a logic circuit (LC1) mounted on the circuit board (PC1) that includes logic for controlling operation of the heating element (26).

12. The cooking appliance (10) of claim 8, wherein the controller comprises a microprocessor (MP1) mounted on the circuit board (PC1) that includes logic for controlling operation of the heating element (26).

13. The cooking appliance (10) of claim 7, characterized in that the cooking chamber (14) comprises a stoneware cooking chamber.

14. The cooking appliance (10) of claim 7, characterized in that the cooking appliance (10) is a slow-cooker, roaster, steamer, pressure cooker or skillet.

15. A method of cooking with a cooking device (10), comprising:
selecting a food product from a predetermined recipe list stored in memory (M) of a controller (28) of the cooking device (10);
selecting a cooking cycle time stored in memory (M) of the controller (28);
activating a cooking profile stored in memory (M) of the controller (28) corresponding to the selected food product and the selected cooking cycle time; and
adjusting with the controller (28) a cooking temperature of the food product being cooked with the cooking device throughout the cooking cycle time according to the cooking profile.

16. The method of claim 15, further comprising;
measuring an actual cooking temperature of the food product being cooked using a temperature indicating device (40).

17. The method of claim 16, further comprising:
inputting the measured actual cooking temperature to the controller (28); and
adjusting electrical power supplied to a heating element (26) of the cooking device (10) with the controller (28) based on the measured actual cooking temperature to adjust the cooking temperature in accordance with the cooking profile for the selected food product and cooking cycle time.

18. The method of claim 17, further comprising:
adjusting electrical power supplied to the heating element (26) with the controller (28) after the cooking cycle time has elapsed to adjust the cooking temperature in the range of 140° to 160° F.

19. The method of claim 17, wherein the controller comprises a microprocessor (MP1) mounted on a circuit board (PC1) that includes logic for controlling operation of the heating element (26).

20. The method of claim 15, wherein the cooking device (10) is a slow-cooker, roaster, steamer, pressure cooker or skillet.
